(19) United States
(12) Patent Application Publication
(10) Pub. No.: US 2006/0139930 A1
(43) Pub. Date: Jun. 29, 2006

(54) Motion-compensating light-emitting apparatus

(76) Inventors: Matthew Feinsod, Great Neck, NY (US); Michael Perlmutter, Sherborn, MA (US)

Correspondence Address: FROMMER LAWRENCE & HAUG, 745 FIFTH AVENUE- 10TH FL., NEW YORK, NY, 10151, US

(21) Appl. No.: 11/315,906

(22) Filed: Dec. 22, 2005

Related U.S. Application Data
(63) Continuation-in-part of application No. 11/022,215, filed on Dec. 23, 2004.

(51) Int. Cl. H01S 3/00

(52) U.S. Cl. 362/276; 362/553; 362/259

(57) ABSTRACT

A light-emitting apparatus, such as a laser pointer, for enabling a spot of light to be projected on a desired target located a distance away such that the spot is projected on the desired target without any or substantially any undesired movement. The apparatus may include a housing, a light generating device located within the housing and operable to generate a beam of light, a sensing device or devices for sensing an undesired action of the housing, a control circuit operable to provide a control signal corresponding to the sensed undesired action, and a drive device operable to counter act all or at least some of the undesired action of said housing in accordance with said control signal.

### BACKGROUND OF THE INVENTION

The present invention relates to light-emitting devices and particularly to those devices intended to produce a beam in a selected direction such as toward a target of interest. The invention provides motion-compensation technology suitable for use with such light-emitting devices, which may dampen and/or substantially eliminate the effect of unintentional motion, vibration, or movements, such as angular movements, caused by mechanical vibrations, hand tremors, and so forth.

Light-emitting devices, such as laser diode devices, are used in a variety of consumer, computer, business, medical, scientific, military, outdoor, telecommunication and industrial products, including but not limited to compact disk (CD) players and computer CD-ROM drives, digital video disk (DVD) players and DVD-ROM drives, laser printers, laser pointers, barcode scanners, measurement devices, rangefinders, scopes, industrial material processing devices, marking and cutting systems, medical equipment, fiber optic transmission systems, satellite communications, and digital printing presses. Many of these applications require precision accuracy for successful implementation. However, conventional light-emitting devices may be affected by unintentional angular movements (e.g., fine vibrations from the machine in which a laser is encased, fine tremors from a shaking hand holding a laser, etc.) and, as a result, generate an unsteady column of light—producing an effect that may cause inferior performance.

There are known in the art devices for example binoculars and cameras that contain lenses designed to capture a wide spectrum of light and focus them on the eyes of a user in a manner that eliminates the appearance of motion to the user. However, the present invention is directed to solving a different and more challenging problem. Specifically, these known devices work to eliminate the movement or shake of a user's hands by selective focusing of the beam of the received light, this light emanates a wide angle of sources and is collected by the lenses. During collection of the wide angle of received light, the beam is focused so that it appears to not to shake when the user views an object through the binoculars. In contrast, a light emitting apparatus presents a unique problem because a light emitting device has a known and relatively narrow point source of light. The point source of light must be controlled in a manner to ensure that the light beam impacts on the desired target some distance away from the point source despite movements of the point source.

An example of the above mentioned effect will now be described with reference to a laser pointer. Fine tremors of the human hand, when holding even a lightweight laser pointer (or other pointing device), have been measured at a frequency range of 1 to 5 Hz. These unwanted vibrations are often amplified when the person maneuvering the device is nervous. The resulting deviation of the projected spot from the intended target point to the actual point is proportional to the distance from the pointing device to the target object (e.g., a point on a screen). This deviation may be approximately equal to the product of the sine or the tangent of the angle and the distance to the projected spot. In other words, for small angular movements (such as less than 10 degrees), the movement of the projected spot is approximately equal to the product of the distance to the target and the angle of the movement (in radians). For instance, small angular movements of +/−1 degree of a laser pointing device may result in movements of approximately +/−2 cm of the projected spot on a target 1 meter away; and, these angular movements will result in a 10-fold larger projected spot movement (approximately +/−20 cm) for a target 10 meters away (which may be typical of large lecture halls). In contrast to angular movements, translational movements (sideways movements of the hand) are not amplified by the distance from the light-emitting device to the target object. That is, if the hand holding a laser pointer is moved sideways by 1 cm, the spot on the target is also moved sideways by 1 cm irrespective of how far the target is from the hand. Thus, only the angular changes (particularly those in the 1 to 5 Hz frequency region, typical for a hand tremor) cause the undesirable movements of the projected light on the target.

### SUMMARY OF THE INVENTION

The present invention provides a motion-compensating light-emitting apparatus which enables a steady beam of light to be projected onto a desired target even if subjected to undesired unsteady conditions by automatically redirecting or compensating for unintentional, off-target angular movements. The present apparatus may use miniature gyroscopes and/or accelerometers and/or other sensing type devices and an optical system including light-refracting elements arranged within the apparatus.

The present apparatus may be lightweight, portable, compact, inexpensive to manufacture and easy to assemble.

In one embodiment of the present invention, a motion-compensating light-emitting device is provided which utilizes two miniature gyroscopes (for example, microelectromechanical system (“MEMS”) such as model ADXRS150 manufactured by Analog Devices, Inc.) arranged to measure vertical and horizontal angular movements (i.e., pitch and yaw) of the device. These gyros may have a relatively small volume (such as less than 0.15 cm³), low weight (such as less than 500 mg), and small size (such as 7 mm×7 mm×3 mm or less).

In another embodiment of the present invention, a motion-compensating light-emitting device is provided which utilizes two or three miniature accelerometers (for example, MEMS, such as model ADXL203 manufactured by Analog Devices, Inc) arranged to measure acceleration and changes of the gravity vector (changes in acceleration) or relative tilts with respect to the vertical axis in two orthogonal directions (i.e., yaw and pitch) and to obtain from this information the relative vertical and horizontal angular movements. These accelerometers may have a relatively small volume 0.05 cm³ (with dimensions of 0.5 cm×0.5 cm×0.2 cm). Additionally, the accelerometers may be provided in a hermetically sealed package.

In the present invention, the sensing device(s) (such as the two gyros or accelerometers) may be arranged so as to interact with an optical apparatus to cause the exiting light rays to be refracted in a compensating or opposite direction to a measured undesired angular movement or motion. For instance, if one of the gyros measures a downward tilt or undesired angular movement of the light-emitting device, then the light rays may be refracted in a proportional amount in the upward direction so as to cancel the effects of the undesired angular movement or vibration. As is to be appreciated, a similar result may also be obtained for undesired angular movements or motions in the left and/or right direction.

In the present invention, the compensating refraction may be accomplished by manipulating or sliding one or more miniature lenses into the light rays before they exit the device. In this regard, as light rays encounter the lens or lenses, they are refracted wherein the exit vergence is a function of the angle of incidence with the respective lens, the thickness and radius of curvature of such lens, and the various indices of refraction through which the light passes.

As an alternative to the above-described movable lens or lenses, two plates, which may be fabricated from glass or an equivalent type material, may be joined or arranged with a bellows and the space between the plates filled with a transparent liquid having a desired refractive index. Such arrangement may serve to refract the light rays. Here, instead of sliding a lens, the bellows may be contracted or expanded to change the angle of refraction of the light rays.

Another embodiment of the instant invention is a light-emitting apparatus using a magnetic compensator to compensate for undesired movement so that a beam of light is projected on a target substantially without any undesired movement. The apparatus includes a light generator, a movement sensor for detecting the undesired movement, and a controller. The controller provides a control signal corresponding to the sensed undesired movement to the magnetic compensator. The magnetic compensator preferably includes one or more permanent magnets and one or more electrical coils, the controlled interaction thereof compensating for the sensed undesired movement and maintaining the location of the beam of light.

Yet a further aspect of the present invention is a laser pointer or light-emitting apparatus that enables a spot of light to be projected on a desired target. The pointer includes a housing, a light generator located within the housing, and sensor for sensing an undesired movement of the housing. The laser pointer also includes a controller which generates a control signal corresponding to the sensed undesired movement and provides this control signal to a magnetic compensator. The magnetic compensator counteracts the undesired movement of the housing so that the spot is projected on the desired target without any undesired movement.

Yet another aspect of the instant invention is a light-emitting apparatus. The apparatus includes a light generator for generating a beam of light and a sensor for detecting any undesired movement of the apparatus. The apparatus also includes a controller which provides a control signal corresponding to the sensed undesired action to a compensator. The compensator compensates for the undesired movement of the apparatus to counter act the undesired movement of the apparatus. The compensator includes at least two mirrors and a driver which positions the at least two mirrors so as to compensate for the undesired movement. The driver moves the mirrors in response to the control signal so that the beam of light is projected on a desired target without any or substantially any undesired movement.

The circuitry utilized to drive the lens, bellows, magnetic compensator, or mirror may be relatively simple. For example, two inverting amplifiers may be arranged to amplify the analog outputs from the MEMS gyros which may be used to form a drive signal for causing the lens, the bellows, the magnetic compensator, or the mirror to be moved in the appropriate direction. It should be noted that while MEMS gyros are described, use of accelerometers or other appropriate movement sensors would be equally applicable and are considered within the scope of the present invention. The present invention is described in more complete detail below with reference being made to the drawing figures, which are also identified below and in which corresponding components are identified by the same reference numerals.

### BRIEF DESCRIPTION OF THE DRAWINGS

FIG. 1 is a diagram of a motion-compensating light-emitting apparatus according to an embodiment of the present invention;

FIG. 2 is a diagram of the motion-compensating light-emitting apparatus of FIG. 1 to which reference is made in explaining the operation thereof;

FIG. 3 is a diagram of a motion-compensating light-emitting apparatus according to another embodiment of the present invention;

FIG. 4 is a diagram of the motion-compensating light-emitting apparatus of FIG. 3 to which reference is made in explaining the operation thereof;

FIG. 5 is a diagram to which reference is made in explaining the operation of one aspect of the present invention;

FIG. 6 is a diagram of a motion-compensating light-emitting apparatus according to another embodiment of the present invention;

FIG. 7 is a diagram of a motion-compensating light-emitting apparatus according to another embodiment of the present invention;

FIG. 8 is a diagram of the motion-compensating light-emitting apparatus of FIG. 7 to which reference is made in explaining the operation thereof;

FIG. 9 is a diagram of a motion-compensating light-emitting apparatus according to another embodiment of the present invention; and

FIG. 10 is a diagram of the motion-compensating light-emitting apparatus of FIG. 9 to which reference will be made in explaining the operation thereof.

### DETAILED DESCRIPTION OF THE PREFERRED EMBODIMENTS

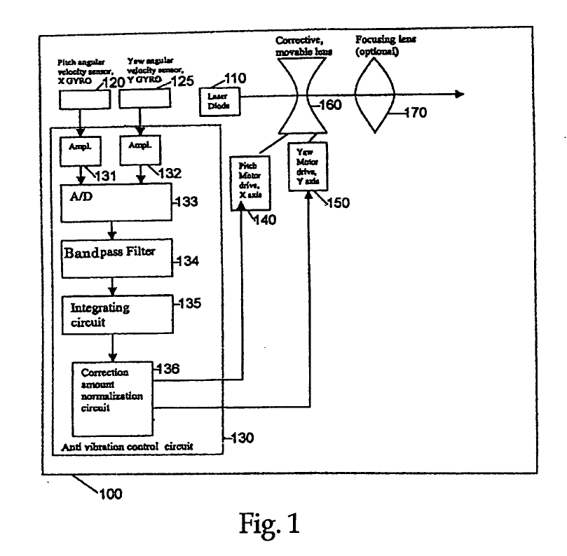

FIG. 1 is a diagram of a laser diode pointer 100 which includes vibration or motion compensation circuitry in accordance with an embodiment of the invention. A visible laser diode 110, or other appropriate light-emitting element, is used as the light source. There are several ways of implementing the vibration compensation scheme. In accordance with an embodiment of the invention, two angular velocity sensors (gyros) 120 and 125 are aligned in orthogonal directions and used to measure the angular movements in the pitch and yaw axis (also referred to as the X and Y axis). The output of gyros 120 and 125 are amplified by two amplifiers 131 and 132 respectively and/or sampled by an A/D converter 133 in anti-vibration control circuit 130. The sampled signal is preferably passed to a band frequency filter 134 where the portion of the signal associated with the rapid, unwanted angular motions of the pointer in this example, typically that portion between 1 and 5 Hz, is extracted. Although a band frequency filter having a range of 1 to 5 Hz is described, a variable frequency filter may be used to set the desired band of frequencies. The range of frequencies may be adjusted by utilizing an adjustment type device such as a variable resistor or digital switches.

The filtered signal is then integrated by an integrating processor circuit 135. Because gyros 120 and 125 measure angular velocity, the signal received by integrating processor circuit 135 is integrated to obtain angular information from which an angular difference may be obtained. Although the embodiment of FIG. 1 utilizes gyros 120 and 125 that measure angular velocity, gyros 120 and 125 may measure an angular difference. In such instance, integrating processor circuit 135 need not be included in the anti-vibration control circuit 130.

The integrated rate output or angular difference (proportional to the angle of the unwanted angular motion) is conditioned by a correction amount normalization circuit 136 (which may include amplifying the signal by a necessary or predetermined amount) and supplied as an input for motors 140 and 150, which are connected to a movable lens 160 (which is located between the laser diode 110 and a focusing lens 170). Movable lens 160 and focusing lens 170 are each preferably constructed from one or more convex lenses and/or concave lenses, or a combination of convex and concave lenses, or one or more convex/concave type lenses, or any combination thereof. The signals are conditioned so that the feedback loops provide an input signal to the motion correction mechanisms such that the resulting circuits are stable in the region of interest. The conditioning may include adjusting the gain of the signal as well as adjusting for the null of the circuit and the zero offset of the gyros. Thus, if the integrated rate output measured is equal to 1 degree, the amplified signal has to equal a voltage (or current) that will produce a motor movement required to move the compensating lens for a one degree of motion.

The anti-vibration control circuit 130 may be part of a microprocessor or microcomputer, or could be constructed out of individual analog and digital elements depending on the cost, size and power consumption of each implementation. Additionally, an on/off switch may be provided in laser diode pointer 100 which may enable a user to turn off the anti-vibration control circuit if the user does not want to use the motion compensating function.

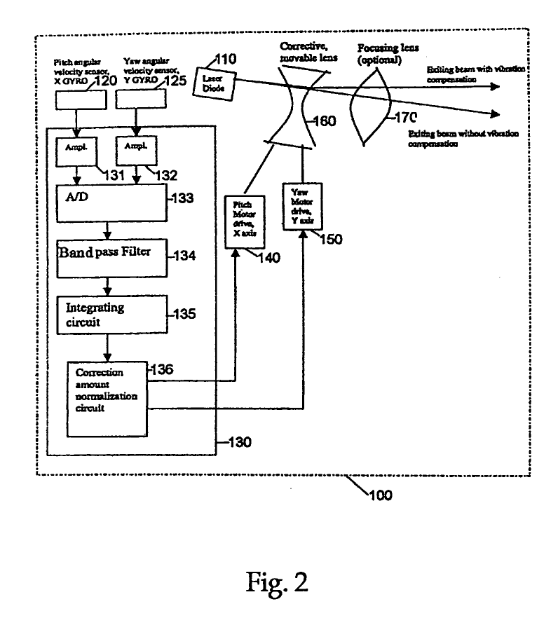

FIG. 2 is a diagram of a laser diode pointer 100 when it is tilted down. The gyros 120 and 125 measure the angular velocity of the tilt, and their output signals (which may be in analog form) are proportional to the angular rate of the motion. Such signals are then preferably amplified, digitized and passed to the band pass frequency filter 134. The band frequency filter 134 extracts the portion of the signal(s) associated with rapid unwanted angular motion (e.g. unwanted hand tremors which may be in the 1 to 5 Hz range). The filtered signals are then integrated by the integrating processor circuit 135. The normalizing and conditioning circuit 136 receives the integrated signal and, in accordance therewith, generates a voltage or current signal having a value or magnitude corresponding to the necessary compensation, and cause the same to be supplied to compensating element(s) (such as motors 140 and 150). In response thereto, the motors 140 and 150 cause the corrective lens 160 to move in a direction such that an exiting beam continues to exit the laser pointer 100 in a horizontal or a substantially horizontal direction. Without the movement of this corrective movable lens 160 the beam would exit at a downward angle. The motors 140 and 150 may alternatively comprise an electro-motor, an electro-magnetic motor, a piezo-electric motor or any other type of actuator suited for this application.

Although not shown in this diagram, laser pointer 100 (which includes the gyros and the anti-vibration circuit) is preferably powered by a power source such as two 1.5V batteries connected in series as used for ordinary laser pointers. To save on power usage, the motion-compensation technology may be activated only upon activation of the laser pointer.

Although FIG. 2 depicts a laser diode pointer 100 tilted on one axis and its resulting compensation, tilting on the other axis would be compensated similarly (and independently) and is not illustrated in order to keep the drawings simple and easy to follow.

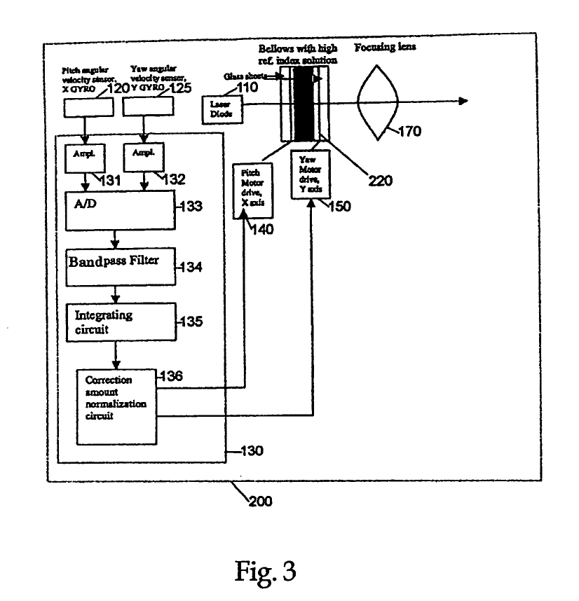

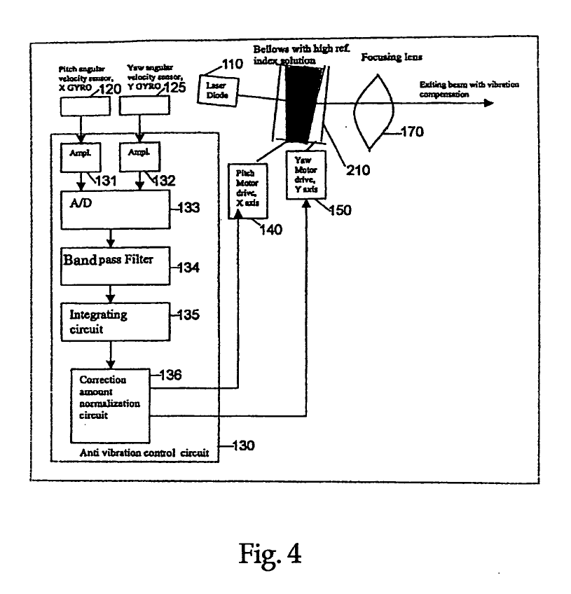

In another embodiment of the invention, and as shown in FIG. 3, a laser diode pointer 200 employs a movable bellows 210 filled with a high refractive index solution or material 220 instead of corrective movable lens 160. The refractive index of the high refractive index solution or material 220 is preferably approximately 1.33 or higher. The high refractive index solution or material 220 may be stored between two sheets of glass 230 and 240 such that the portion of the high refractive index solution in the path of the optical beam is adjusted (by squeezing or spreading the bellows) based on the angular rates measured by the two angular velocity sensors or gyros 120 and 125. Instead of moving an optical lens to change the direction of the exiting beam the bellows filled with high refractive index solution may be contracted on one end and expanded on the other end so as to bend the exiting light beam in a direction opposite to the unwanted motion. FIG. 4 shows how such a change in the thickness or arrangement of the bellows causes the beam to bend so as to compensate for the unwanted motion. As in the previously described laser pointer having a movable lens, the laser pointer 200 may be powered by a power source such as a number of batteries arranged in a predetermined manner. Additionally, FIGS. 3 and 4 indicate how motion in the pitch or X axis is compensated; however, motion in the yaw or Y axis are compensated for similarly (and independently) and is not illustrated in order to keep the drawings simple and easy to follow.

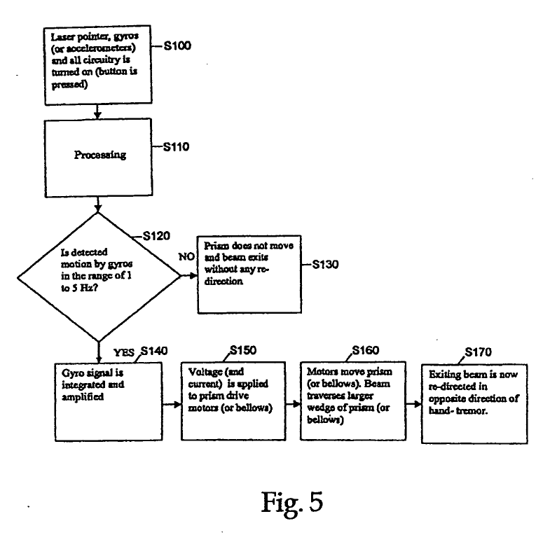

FIG. 5 is a flow chart describing how a laser pointer in accordance with an embodiment of the present invention compensates for unwanted motion. The process starts in step S100 where the laser pointer is turned on by pressing a button or the like. During operation of the laser pointer, a sensing means, which may include gyros or accelerometers or a combination thereof, measures movement and output a signal which is processed by the anti-vibration control circuit. Such processing includes the analog to digital conversion performed by the A/D converter 133. Processing then proceeds to step S120 wherein the signal is supplied through a band pass filter so as to effectively detect and extract signals corresponding to the unwanted motion of the laser pointer (unwanted motion may be in the 1 to 5 Hz range). If the sensing means does not detect unwanted motion, and therefore the inquiry at step 120 is answered in the negative, the method proceeds to step S130 where the correcting lens or bellows is not moved and the beam exits the laser pointer with out any redirection. If there is unwanted motion detected by the sensing means and therefore the inquiry at step 120 is answered in the affirmative, the method proceeds to step S140 where the processed signal is integrated and/or amplified. A voltage or current corresponding to the processed and/or amplified signal is applied to the drive motors in step S150, which in turn, move the prism or the bellows in step S160. In step S170, the beam is redirected in the direction opposite the direction of the hand tremor.

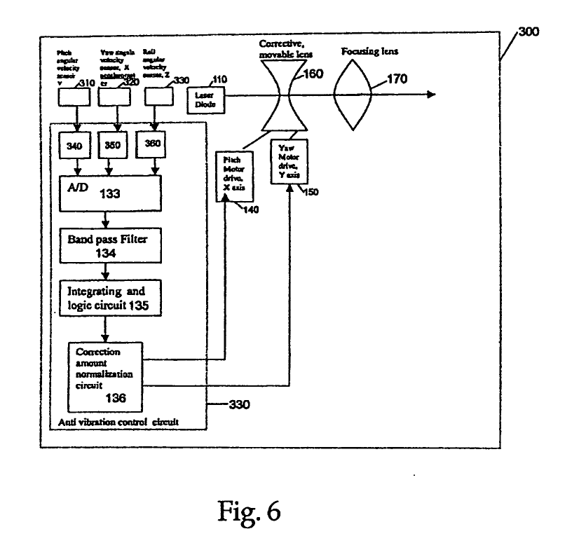

FIG. 6 is a diagram of another embodiment of the laser diode pointer 300 wherein accelerometers are utilized instead of gyroscopes. Three angular velocity sensors (accelerometers) 310, 320, and 330, which are aligned in orthogonal directions, measure the angular movements in the pitch, yaw and roll axis (also referred to as the X, Y and Z axis) respectively. The output of accelerometers 310, 320, and 330 are respectively amplified by three amplifiers 340, 350, and 360, and then sampled by A/D converter 133 in the anti-vibration control circuit 330. The portion of the signal associated with rapid unwanted angular motions of the pointer (e.g., an unwanted hand tremor in the 1-5 Hz range) is extracted by band pass filter 134 and integrated by integrating processor circuit 135. Movements (tilts) of the laser pointer are measured by comparing the measured acceleration to a gravity vector (g acceleration) as the laser pointer is tilting and/or computing the motions from the three orthogonal measurements of the acceleration.

The computed integrated rate output from the integrating processor circuit 135, which is typically proportional to the angle of the unwanted angular motion may be conditioned, including for example amplifying the signal by a necessary or predetermined amount, and/or used as the input for motors 140 and 150 coupled to movable lens 160 and located between the laser diode 110 and the focusing lens 170. The anti-vibration circuit 330 may be included in a microprocessor or microcomputer or may be constructed out of individual analog and/or digital elements depending on the cost, size and power consumption requirements.

In another embodiment of the present invention, instead of using only a compensating device in front of the light emitting device, the light emitting device itself can be made to tilt in opposite direction to the undesired angular movement that is measured by the gyros or accelerometers. Thus, the light emitting device (such as a laser diode) is anchored in the center of a two axis gimbaled configuration. Movement of the gimbaled light emitting device is accomplished by means of two electro-coils (or two motors) that are now part of the light emitting device system. Two permanent magnets placed on both sides as well as above and below the light emitting device (four (4) magnets in total) form the complete system enabling a tilt of the light emitting device when current flows through the coils. In this configuration a current in one direction through the coils causes a tilt of the light emitting device to one side (e.g., up) while a current in the opposite direction through the coil causes a tilt of the electro coil to the other side (e.g., down).

In all embodiments, an optical system such as lenses, bellows or mirrors may be used to further refract the light as it exits the device.

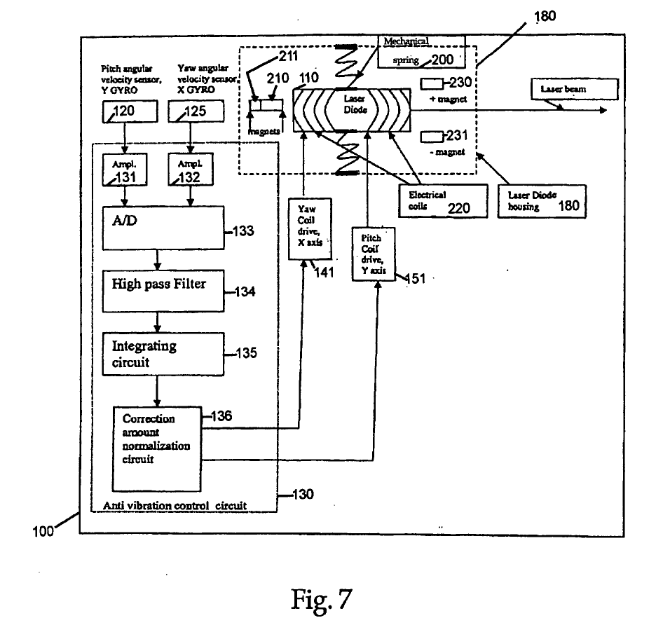

FIG. 7 is a diagram of a further embodiment of a motion compensating light emitting device constructed in accordance with the invention. In this example a visible laser diode 110 is used as the light source. Two angular velocity sensors (gyros) 120 and 125 aligned in orthogonal directions are used to measure the angular movements in the pitch and yaw axis (also referred to as the X and Y axis). The output of these gyros is amplified by two amplifiers 131 and 132 and then sampled by an A/D converter 133 in the anti vibration control circuit 130. The frequency portion of the signal, which is associated with rapid unwanted angular motions of the pointer in this example, is then integrated by an integrating processor 135 and produces an integrated rate output. The integrated rate output (proportional to the angle of the unwanted angular motion) is then conditioned (amplified by the required amount) and used as the input for the two electro coils 220 that are wound around the laser diode module 110. The interconnection of the integrating circuit 135 and the electrical coils 220 is not shown in FIG. 7. There are four permanent magnets 210, 211, 230, and 231 situated to the left, right, up and down positions around the laser diode module. In this example the up and down magnets 230 and 231 are in front of the laser diode module 110 where the laser beam exits while the left and right magnets 210 and 211 are behind the exiting beam area of laser diode module 110. These magnets cause the electro-coils 220 to deflect the laser diode module 110 when current is allowed to flow through the electro-coils 220. Current through an electro-coil causes the formation of a magnetic field and if the magnetic field is of opposite polarity of the nearby permanent magnet then the laser diode module 110 will deflect as the magnetized portions try to move closer to each other. The laser diode module 110 is mounted with one or more mechanical springs 200 connected to the laser diode housing 180 so that without any electrical current to the electro-coils the laser diode module 110 is not deflected to either side or up and down.

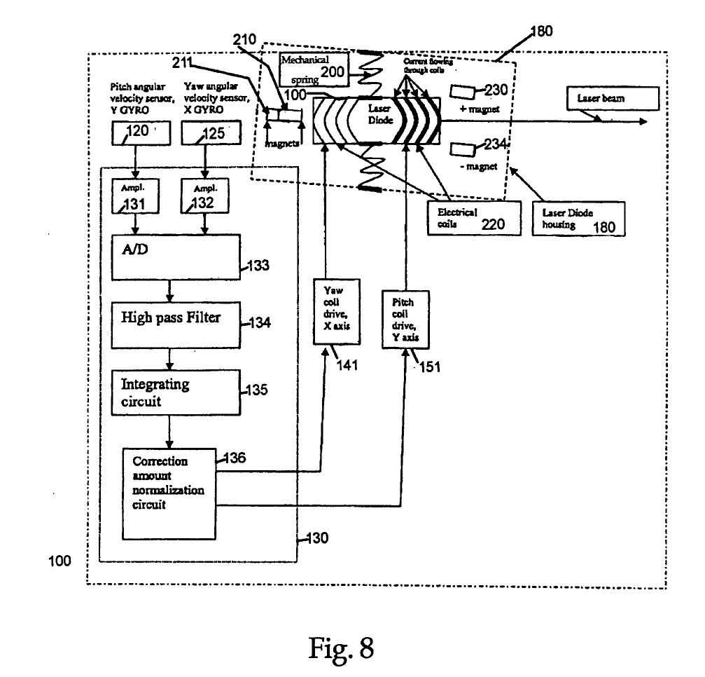

FIG. 8 shows the effect on the light emitting device of FIG. 7 when, for example, rapid motion of a hand tremor causes the light emitting device to tilt down. The gyros 120 and 125 measure the angular velocity of the tilt and their (analog) output is proportional to the angular rate of the motion. The signal is then amplified, digitized and if the angular motion (tilting up) is very rapid caused for example by an unwanted tremor in the 1-5 Hz range, the signal is then passed through the high frequency filter 134 and integrated by the integrating circuit 135. The normalizing and conditioning circuit 136 then sends a signal to the electro-coil drivers 141 and 151 to move the laser diode module 110, as shown in FIG. 8 this is movement in the direction of the positive magnet 230, so that the exiting beam continues in a horizontal direction even though the housing 180 was tilted downward by the unwanted hand tremor. Without the movement of this corrective motion, caused by the attraction of the magnetized coil to the magnet, the beam would exit at a downward angle.

One of skill in the art will appreciate that FIGS. 7 and 8 are simplified drawings and do not depict certain features such as for example the power supply connections to the gyros and the anti-vibration circuit. As an example, for use in a handheld laser pointer, a power supply may consist of two 1.5V batteries connected in series as used for ordinary laser pointers, to power the laser diodes.

The forgoing examples indicate how motion in one axis, here the Y axis or pitch which is in the plane of the paper is measured and compensated. However, the invention is not so limited and motion in the X axis or Yaw can also be compensated by the present invention.

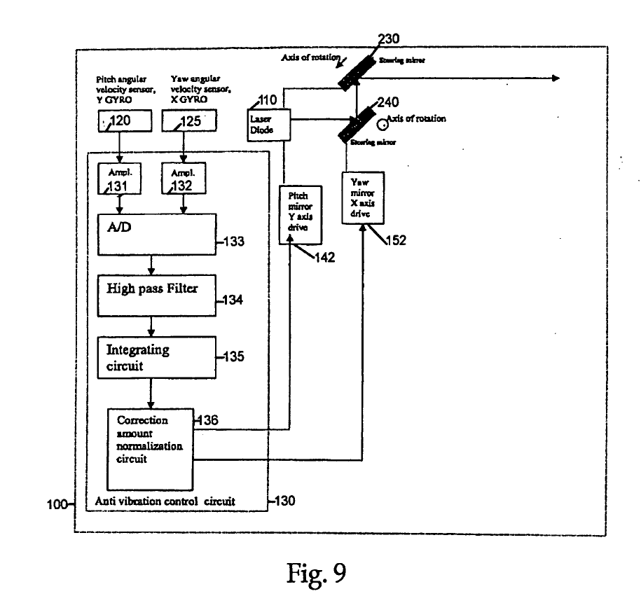

FIG. 9 depicts another embodiment of a motion compensating light emitting device, with motion compensation accomplished by a system employing movable mirrors. Vibration compensation can also be accomplished by means of MEMS micro-mirrors where single axis (or two axis) beam steering can be accomplished using surface micro-machined technology. Recent developments in this area have produced 2 axis micro-mirrors where two orthogonal motions in one device are achieved over angles greater than 10 degrees making such a motion compensation device very compact, using very simple circuitry and very little power. (An example of such devices can be found at Aksyuk V. A. et al., Optical Fiber Conference OFC 2002 Post Deadline Paper1).

In accordance with one embodiment of the invention a visible laser diode module 110 is used as the light source. A vibration compensation technique, in accordance with the invention, employing two angular velocity sensors gyros 120 and 125 are aligned in orthogonal directions and are used to measure the angular movements in the pitch and yaw axis (also referred to as the X and Y axis, respectively). One of skill in the art will readily appreciate that although described here in conjunction with MEMS gyros, accelerometers can also be used instead of gyros, further, the use of other appropriate movement sensors are also considered within the scope of the instant invention. The output of these gyros 120 and 125 is amplified by two amplifiers 131 and 132 and sampled by an A/D converter 133 in the anti-vibration control circuit 130. The frequency portion of the signal (associated with rapid unwanted angular motions of the pointer in this example) is then integrated by an integrating processor. This integrated rate output, which is preferably proportional to the angle of the unwanted angular motion is then conditioned by the correction amount normalization circuit 136, amplified by a predetermined amount and used as the input for the two mirrors drivers 142 and 152 that drive the two movable mirrors 230 and 240. Mirror motion can be accompanied by means of electromechanical devices such as those commonly used for vibrating galvanometric mirrors. In this arrangement a small mirror 240 is mounted on the axis of an electro-motor. If current is applied to the windings of the motor, the motor will turn thus causing the mirror to rotate and change the deflection of the incident beam.

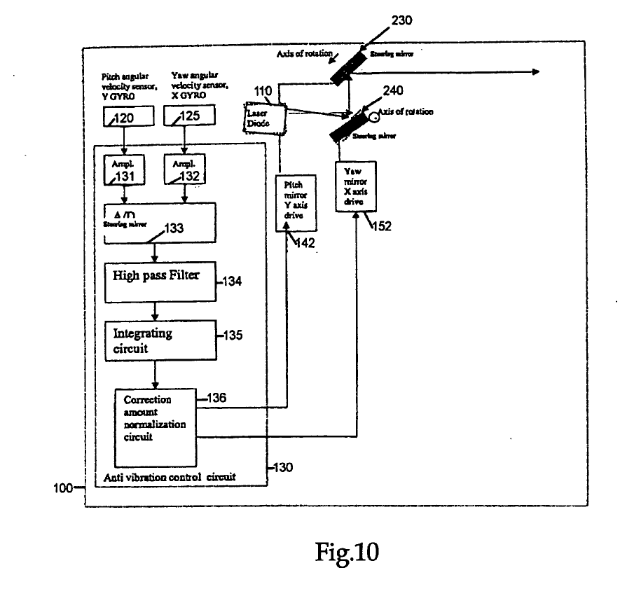

Vibration compensation occurs as shown in FIG. 10, where a light emitting device, for example a laser pointer is tilted down. The gyros 120 and 125 measure the angular velocity of the tilt and their (analog) output is proportional to the angular rate of the motion. The signal is then amplified by amplifiers 131 and 132, digitized by and A/D converter 133 and if the angular motion is very rapid, as for example caused by an unwanted tremor in the 1-5 Hz range, the signal is then passed through the high frequency filter 134 and integrated by the integrating circuit 135. The normalizing and conditioning circuit 136 then sends a signal to the motor 142 and 152 to move the mirrors 230 and 240. The mirrors 230 and 240 are attached to the shafts of the motors 142 and 152 and rotate in their respective directions so that the first reflected beam continues in a vertical direction, and the second reflected beam continues in a horizontal direction even though the laser diode 110 was tilted downward by the unwanted hand tremor. Though discussed herein with respect to compensation for movement in the Y direction, the present invention is not so limited and may be used to compensate for movement in the X, Y, and Z directions.

Although the above embodiments describe laser pointers that may utilize specific combinations of gyroscopes or accelerometers, the present invention is not so limited. For example, the present invention may also utilize other types of sensing devices or may utilize a different number of gyroscopes or accelerometers or may utilize a combination of gyroscopes and accelerometers to sense unwanted motion. Further, although preferred embodiments of the present invention and modifications thereof have been described in detail herein, it is to be understood that this invention is not limited to those precise embodiments and modifications, and that other modifications and variations may be effected by one skilled in the art without departing from the spirit and scope of the invention as defined by the appended claims.

What is claimed is:

1. A light-emitting apparatus comprising:
generating means for generating a beam of light;
sensing means for sensing an undesired action of the generating means;
control means for providing a control signal corresponding to the sensed undesired action; and
compensating means for compensating for the sensed undesired action so that the beam of light is projectable on a target without any or substantially any undesired movement.

2. The light-emitting apparatus of claim 1, wherein the sensing means includes one or more gyroscopes.

3. The light-emitting apparatus of claim 2, wherein the one or more gyroscopes are rate-sensing gyroscopes so that each gyroscope provides an output signal indicative of an angular velocity.

4. The light-emitting apparatus of claim 3, wherein the compensating means includes integrating means for integrating angular velocity signal derived from the one or more gyroscopes to provide an integrated signal indicative of an undesired angular movement of the generating means.

5. The light-emitting apparatus of claim 2, wherein the compensating means includes band pass filter means for receiving signals derived from the one or more gyroscopes and for allowing only the signals within a predetermined frequency range to pass therethrough.

6. The light-emitting apparatus of claim 5, wherein said predetermined frequency range is approximately between 1 and 5 Hz.

7. The light emitting apparatus of claim 1, wherein said compensating means comprises at least one electrical coil.

8. The light emitting apparatus of claim 7, wherein said compensating means further comprises at least one permanent magnet corresponding to each of the at least one electrical coil.

9. The light emitting apparatus of claim 8, wherein said compensating means further comprises two magnets and one electrical coil for compensating movement of the generating means in a first direction and two magnets and one electrical coil for compensating movement of the generating means in a second direction.

10. The light emitting apparatus of claim 7, wherein upon application of a voltage or current to one or more of the at least one electrical coils, a magnetic field is created, the magnetic field interacting with the magnetic field of corresponding one or more of the at least one permanent magnets to move or prevent the undesired movement of the generation means.

11. The light emitting apparatus of claim 1, further comprising at least one spring.

12. The light emitting apparatus of claim 1, wherein the compensating means is a magnetic compensating means that causes a movement of one or more of the generating means, a lens, or a mirror against the biasing force of the at least one spring to compensate for the sensed undesired action of the generating means.

13. The light-emitting apparatus of claim 1, wherein the sensing means includes one or more accelerometers.

14. The light-emitting apparatus of claim 13, wherein the one or more accelerometers are rate-sensing accelerometers so that each accelerometer provides an output signal indicative of an angular velocity.

15. The light-emitting apparatus of claim 14, wherein the compensating means includes integrating means for integrating angular velocity signal derived from the one or more accelerometers to provide an integrated signal indicative of an undesired angular movement of the generating means.

16. The light-emitting apparatus of claim 13, wherein the compensating means includes band pass filter means for receiving signals derived from the one or more accelerometers and for allowing only the signals within a predetermined frequency range to pass therethrough.

17. The light-emitting apparatus of claim 16, wherein said predetermined frequency range is approximately between 1 and 5 Hz.

18. A method for emitting light from a light-emitting apparatus, comprising the steps of:
generating a beam of light from a light source;
sensing an undesired action of the light source;
providing a control signal corresponding to the sensed undesired action; and
compensating for the sensed undesired action so that the beam of light is projectable on a target without any or substantially any undesired movement

19. The method of claim 18, wherein the undesired action of the light source is sensed by one or more gyroscopes.

20. The method of claim 19, wherein the one or more gyroscopes are rate-sensing gyroscopes, and wherein each gyroscope performs a step of providing an output signal indicative of an angular velocity.

21. The method of claim 20, wherein the compensating for the sensed undesired action is performed in accordance with the steps of:
integrating an angular velocity signal derived from the one or more gyroscopes; and
providing an integrated signal indicative of an undesired angular movement of the generating means.

22. The method of claim 19, wherein the compensating for the sensed undesired action is performed in accordance with the steps of:
receiving signals derived from the one or more gyroscopes; and
allowing only the signals within a predetermined frequency range to pass therethrough.

23. The method of claim 22, wherein said predetermined frequency range is approximately between 1 and 5 Hz.

24. The method of claim 18, wherein the compensating for the sensed undesired action is performed in accordance with at least one electrical coil.

25. The method of claim 24, wherein said compensating for the sensed undesired action is further performed in accordance with at least one permanent magnet corresponding to each of the at least one electrical coil.

26. The method of claim 24, wherein said compensating for the sensed undesired action is further performed in accordance with two magnets and one electrical coil, capable of performing a step of:
compensating for the undesired action of the light source in a first direction, said compensating for the sensed undesired action is further performed in accordance with two magnets and one electrical coil, capable of performing a step of:
compensating for the undesired action of the light source in a second direction.

27. The method of claim 24, further comprising steps of:
applying a voltage or current to one or more of the at least one electrical coils, creating a magnetic field, the magnetic field interacting with the magnetic field of corresponding one or more of the at least one permanent magnets; and
moving or preventing the undesired action of the light source.

28. The method of claim 18, wherein the compensating for the sensed undesired action is performed in accordance with at least one spring.

29. The method of claim 18, wherein the compensating for the sensed undesired action is performed in accordance with the step of:
causing a movement of one or more of the light source, a lens, or a mirror to compensate for the sensed undesired action of the light source.

30. The method of claim 18, wherein the sensing of the undesired action is performed in accordance with one or more accelerometers.

31. The method of claim 30, wherein the one or more accelerometers are rate-sensing accelerometers, and wherein the rate-sensing gyroscopes perform a step of:
providing an output signal indicative of an angular velocity.

32. The method of claim 31, wherein the compensating for the sensed undesired action is performed in accordance with the steps of:
integrating an angular velocity signal derived from the one or more accelerometers; and
providing an integrated signal indicative of an undesired angular movement of the light source.

33. The method of claim 30, wherein the compensating for the sensed undesired action is performed in accordance with the steps of:
receiving signals derived from the one or more accelerometers; and
allowing only the signals within a predetermined frequency range to pass therethrough.

34. The method of claim 33, wherein said predetermined frequency range is approximately between 1 and 5 Hz.

35. A laser pointer apparatus usable by an operator for enabling a spot of light to be projected on a desired target located a distance away from the operator, said apparatus comprising:
a housing;
generating means located within said housing for generating a beam of light;
sensing means for sensing an undesired action of said housing;
control means for providing a control signal corresponding to the sensed undesired action; and
counter acting means for counter acting at least some of the undesired action of said housing in accordance with said control signal so that the spot is projectable on the desired target without any or substantially any undesired movement.

36. The laser pointer apparatus of claim 35, wherein said sensing means, said control means, and counter acting means are arranged in said housing.

37. The laser pointer apparatus of claim 35, wherein the sensing means includes one or more gyroscopes, rate-sensing gyroscopes, or accelerometers, capable of providing an output signal indicative of angular velocity.

38. The laser pointer of claim 37, wherein the sensing means includes a combination of gyroscopes and accelerometers.

39. The laser pointer apparatus of claim 35, wherein the sensing means includes one or more gyroscopes and wherein the one or more gyroscopes are rate-sensing gyroscopes so that each gyroscope provides an output signal indicative of an angular velocity.

40. The laser pointer apparatus of claim 35, wherein the control means includes integrating means for integrating angular velocity signals derived from the sensing means to provide an integrated signal indicative of an undesired angular movement of the housing.

41. The laser pointer apparatus of claim 35, wherein the control means includes band pass filter means for receiving signals derived from the sensing means and for allowing only the signals within a predetermined frequency range to pass therethrough.

42. The laser pointer apparatus of claim 41, wherein said predetermined frequency range is approximately between 1 and 5 Hz.

43. The laser pointer apparatus of claim 35, wherein said compensating means comprises at least one electrical coil.

44. The laser pointer apparatus of claim 43, wherein said compensating means comprises a plurality of permanent magnets.

45. The laser pointer apparatus of claim 44, wherein said plurality of permanent magnets comprises two magnets for compensating movement in a first direction and two magnets for compensating movement in a second direction.

46. The laser pointer of claim 44, wherein the permanent magnets compensate for undesired movement of one or more of the generating means, a lens, or a mirror.

47. The laser pointer of claim of claim 46, wherein upon application of a voltage or current to said at least one electrical coil, a magnetic field is created, the magnetic field interacts with the magnetic field of the permanent magnets to move or prevent the undesired movement.

48. The laser pointer apparatus of claim 35, further comprising at least one spring for presenting a biasing force against the movement of the generating means relative to the housing.

49. A light-emitting apparatus comprising:
a light generating device which is operable to generate a beam of light;
a sensing device operable to sense an undesired action of the generating device;
a controller for providing a control signal corresponding to the sensed undesired action; and
a controller operable to compensate for the sensed undesired action of the light generating device, said controller controlling at least two mirrors and a drive means operable to position said at least two mirrors so as to counter act at least some of the undesired action of said light generating device in accordance with said control signal so that the beam of light is projectable on the desired target without any or substantially any undesired movement.

50. The light-emitting apparatus of claim 49, wherein the sensing device includes one or more gyroscopes, rate sensing gyroscopes, or accelerometers, capable of providing an output signal indicative of angular velocity.

51. The light-emitting apparatus of claim 50, wherein the sensing device includes a combination of gyroscopes and accelerometers.

52. The light-emitting apparatus of claim 49, wherein the sensing device comprises one or more gyroscopes, said gyroscopes being rate-sensing gyroscopes so that each gyroscope provides an output signal indicative of an angular velocity.

53. The light-emitting apparatus of claim 52, wherein the controller includes an integrator operable to integrate an angular velocity signal derived from the one or more gyroscopes to provide an integrated signal indicative of an undesired angular movement of the light generating device.

54. The light-emitting apparatus of claim 52, wherein the controller includes a band pass filter operable to receive signals derived from the one or more gyroscopes and to allow only the signals within a predetermined frequency range to pass therethrough.

55. The light-emitting apparatus of claim 54, wherein said predetermined frequency range is approximately between 1 and 5 Hz.

56. The light emitting apparatus of claim 49, wherein said light emitting apparatus is a laser pointer.

57. A light-emitting apparatus comprising:
a light generator;
a movement sensor for detecting the undesired movement of the apparatus;
a controller for producing a control signal; and
a compensator to compensate for undesired movement of the apparatus;
wherein upon detection of an undesired movement by the movement sensor, the controller provides a control signal corresponding to the sensed undesired movement to the compensator which compensates for the sensed undesired movement and substantially maintains the location of the beam of light.

58. A laser pointer for projecting a spot of light on a target comprising;
a housing;
a light generator located within the housing;
a sensor for sensing an undesired movement of the housing;
a controller for generating a control signal corresponding to the sensed undesired movement; and
a compensator, wherein upon sensing of an undesired movements the controller produces a control signal and provides the control signal to the compensator which counteracts the undesired movement of the housing so that the spot of light is projected on the desired target substantially without any undesired movement.

59. A light-emitting apparatus comprising:
a light generator for generating a beam of light;
a sensor for detecting any undesired movement of the apparatus;
a controller which produces a control signal corresponding to the sensed undesired action; and
a compensator for counteracting a sensed undesired movement of the apparatus;
wherein the compensator comprises at least two mirrors and a driver, said driver positions the at least two mirrors so as to compensate for the undesired movement in response to the control signal so that the beam of light is projected on a desired target substantially without any undesired movement.
